(19) United States
(12) Patent Application Publication
(10) Pub. No.: US 2025/0315947 A1
(43) Pub. Date: Oct. 9, 2025

(54) ECHOCARDIOGRAPHIC ESTIMATION OF RIGHT ATRIAL PRESSURE USING A LIGHTWEIGHT AND OPEN-WORLD ARTIFICIAL INTELLIGENCE SYSTEM

(71) Applicant: The united States of America,as represented by the Secretary, Department of Health and Human Serice, Bethesda, MD (US)

(72) Inventors: Ghadh A. Alzamzmi, Rockville, MD (US); Sameer K. Antani, Montgomery Village, MD (US); Li-Yueh Hsu, Vienna, VA (US); Vandana Sachdev, Vienna, VA (US); Sivarama Krishnan Rajaraman, Bethesda, MD (US)

(73) Assignee: The united States of America,as represented by the Secretary, Department of Health and Human Serice, Bethesda, MD (US)

(21) Appl. No.: 18/872,402

(22) PCT Filed: Jun. 9, 2023
(86) PCT No.: PCT/US2023/024902

§ 371 Date: Dec. 6, 2024

Related U.S. Application Data
(60) Provisional application No. 63/350,720, filed on Jun. 9, 2022.
(60) Provisional application No. 63/458,054, filed on Apr. 7, 2023.

(51) Int. Cl. G06T 7/00; G06T 7/11; G06V 10/762; G06V 10/764; G06V 20/70

(52) U.S. Cl. CPC G06T 7/0012; G06T 7/11; G06V 10/762; G06V 10/764; G06V 20/70; G06T 2207/20081; G06T 2207/20084; G06T 2207/30048; G06T 2207/30101

(57) ABSTRACT

An Artificial Intelligence (AI) system for estimating inferior vena cava (IVC) collapsibility and right atrial pressure (RAP) from an echocardiography study in real-time is provided. The system includes an image retrieval network that is configured to receive images from the echocardiography study and perform a quality assessment of the images to generate selected images. The system further includes a region segmentation network to localize and segment the selected images to obtain IVC regions in the selected images. The system further includes an IVC quantification and RAP estimation network to perform a distance calculation to find a diameter in the IVC regions at different spatial and temporal points, allowing a more reliable estimation of RAP values; and the system further includes an open-world active learning system comprising a classification engine and a clustering engine.

### CROSS-REFERENCE TO RELATED APPLICATIONS

This patent application claims the benefit of U.S. Provisional Patent Application No. 63/458,054, filed Apr. 7, 2023, and 63/350,720, filed Jun. 9, 2022, which are incorporated by reference.

### STATEMENT REGARDING FEDERALLY SPONSORED RESEARCH OR DEVELOPMENT

This invention was made with Government support under Grant Numbers LM010018, Z99CL999999 and HL006199 awarded by respective institutes at the National Institutes of Health. The Government has certain rights in this invention.

### BACKGROUND OF THE INVENTION

An echocardiogram (“echo”) is performed by using a dedicated bedside or portable imaging system to capture an ultrasound image of the heart and its associated anatomical structures. The use of ultrasound to capture cardiac structure and function has several advantages over other imaging modalities including high temporal resolution, non-invasiveness, low cost, and portability. The images/videos captured in an echo study are usually analyzed manually by a sonographer or cardiologist who interprets the results to guide diagnosis, treatment plan, and prognosis of different cardiovascular diseases. However, this manual analysis is time-consuming and requires a high level of training, which can be costly or hindered by the lack of expertise in low-resource regions. Further, human interpretation can be subjective and inconsistent due to idiosyncratic factors leading to poor reproducibility which may affect patient management or treatment outcomes. Therefore, accurate and automated analysis of echocardiograms presents the potential to mitigate these issues: 1) it can introduce efficiencies thereby enabling the physicians' more analytical time; 2) it can provide consistent and reproducible results; and 3) it may enhance clinical interpretation and decision making.

### BRIEF SUMMARY OF THE INVENTION

In a particular aspect of the disclosure, an Artificial Intelligence (AI) system for estimating inferior vena cava (IVC) collapsibility and right atrial pressure (RAP) from an echocardiography study in real-time is provided. The system comprising: an image retrieval network configured to receive images from the echocardiography study and performs a quality assessment of the images to generate selected images; a region segmentation network, the region segmentation network configured to localize and segment the selected images to obtain IVC regions in the selected images; an IVC quantification and RAP estimation network, the IVC quantification and RAP estimation network configured to perform a distance calculation to find a diameter in the IVC regions at different spatial and temporal points; and an open-world active learning system, the open-world active learning system comprising a classification engine and a clustering engine. By performing IVC thickness calculations and collapsibility analysis at different spatial locations as well as different temporal time points, the AI system can be more reliably measure IVC and RAP values.

In another aspect of the disclosure, a method for estimating inferior vena cava (IVC) collapsibility and right atrial pressure (RAP) from an echocardiography study in real-time performed by an Artificial Intelligence (AI) system is provided. The method comprising: receiving images from the echocardiography study and performing a quality assessment of the images to generate selected images; localizing and segmenting the selected images to obtain IVC regions in the selected images; performing a distance calculation to find a diameter in the IVC regions at different spatial and temporal points; classifying known views and unknown views in the selected images; and grouping the unknown views into one or more clusters used to update classification capability in the AI system. By performing IVC thickness calculations and collapsibility analysis at different spatial locations as well as different temporal time points, the method is able to more reliably measure IVC and RAP values.

In yet another aspect of the disclosure, a non-transitory computer readable medium implemented in an Artificial Intelligence (AI) system for estimating inferior vena cava (IVC) collapsibility and right atrial pressure (RAP) from an echocardiography study in real-time is provided. The non-transitory computer readable medium comprising instructions that when executed by a computer, configure the computer to perform steps comprising: receiving images from the echocardiography study and performing a quality assessment of the images to generate selected images; localizing and segmenting the selected images to obtain IVC regions in the selected images; performing a distance calculation to find a diameter in the IVC regions at different spatial and temporal points; classifying known views and unknown views in the selected images; and grouping the unknown views into one or more clusters used to update classification capability in the AI system. By performing IVC thickness calculations and collapsibility analysis at different spatial locations as well as different temporal time points, the AI system is able to more reliably measure IVC and RAP values.

### BRIEF DESCRIPTION OF THE SEVERAL VIEWS OF THE DRAWING(S)

FIG. 1 illustrates a diameter of an IVC being measured perpendicularly to an IVC long axis, in accordance with an embodiment of the disclosure;

FIG. 2 illustrates an end-to-end and automated AI system 200 for estimating IVC collapsibility and RAP in real-time, in accordance with a particular embodiment of the disclosure;

FIG. 3 illustrates IVC segmentation, in accordance with a particular embodiment of the disclosure;

FIG. 4 illustrates an IVC diameter per frame plotted as a temporal signal, in accordance with a particular embodiment of the disclosure;

FIG. 5 illustrates correlation and Bland-Altman plots in accordance with a particular embodiment of the disclosure as compared to standard manual IVC quantification;

FIG. 6 illustrates a confusion matrix in accordance with a particular embodiment of the disclosure;

FIG. 7 illustrates an IVC retrieval network, in accordance with a particular embodiment of the disclosure;

FIG. 8 illustrates a Trilateral Attention Network (TaNET), in accordance with a particular embodiment of the disclosure;

FIG. 9 illustrates steps of a path fusion, in accordance with a particular embodiment of the disclosure; and

FIG. 10 illustrates an open-world learning process, in accordance with a particular embodiment of the disclosure.

### DETAILED DESCRIPTION OF THE INVENTION

Accurate estimate of right atrial pressure (RAP) by echocardiography is critical for evaluating hemodynamic and intravascular volume status and guiding clinical decision-making to provide optimal patient care. Embodiments of the present disclosure provide an echocardiography artificial intelligence (AI) system that is capable of estimating inferior vena cava (IVC) collapsibility and RAP in real-time. This system employs a lightweight and open-world architecture to rapidly generate reproducible and interpretable results. The lightweight feature facilitates integration of the system into handheld devices, which can enhance accessibility, and the open-world feature makes the system more robust in detecting new/unknown/unpredictable cases or scenarios in real-world clinical settings.

Embodiments of the present disclosure provide: 1) automated echocardiography assessment of IVC diameter and collapsibility as well as RAP estimation; 2) lightweight system for real-time quantitative echocardiography assessment; and 3) open-world system for active echocardiography interpretation and learning.

The inferior vena cava (IVC) is the vessel responsible for circulating deoxygenated blood from the lower extremities and abdomen back to the right atrium. Several studies [3, 4, 7] reported that the IVC diameter and its change with inspiration (a.k.a., IVC collapsibility) can be easily captured using ultrasound imaging devices and used to determine the patient's fluid status in various settings such as acute heart failure (HF) or critically ill patients. IVC collapsibility is measured based on the difference between the maximum and minimum diameters. This collapsibility can be used to readily estimate right atrial pressure (RAP) as follows [7]: an IVC diameter of 2.1 cm that collapses >50% supports an estimated RA pressure of 3 mm Hg (range, 0-5 mm Hg) while an IVC diameter of 2.1 cm that collapses <50% supports an estimated RA pressure of 15 mm Hg (range, 10-20 mm Hg). RAP is a critical metric of right ventricular diastolic function, volume status, and right heart compliance, and it has been used as a predictor of mortality in patients with heart failure and cardiogenic shock.

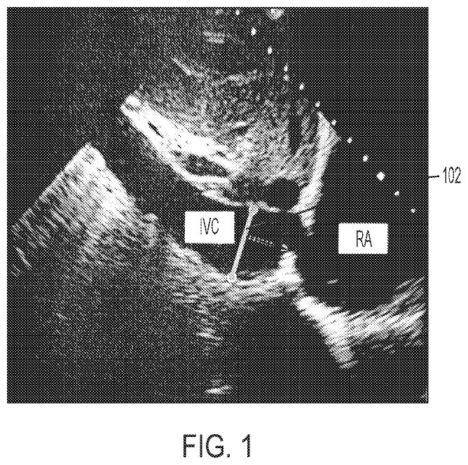

Clinically, IVC diameter is measured perpendicular to a long axis 102 of the IVC within 1.0 to 2.0 centimeters of the cavo-atrial junction as shown in FIG. 1. Then, the collapsibility is visually estimated based on the changes in IVC diameter with inspiration. Specifically, the current practice of estimating IVC and RAP involves several steps. First, a cardiologist needs to manually select the subcostal long-axis view of the IVC and visually assess the view quality. Then, s/he needs to measure IVC diameter in the correct location and determine collapsibility. Finally, RAP is estimated manually by integrating the determined IVC collapsibility into a given formula. This practice is 1) time-consuming and prone to errors, 2) inaccurate as it relies on a cardiologist's manual and visual assessment, and 3) suffers from subjectivity and inconsistency, which may lead to variable decision-making. Given that IVC collapsibility has a strong potential for predicting patients' fluid status in cardiac and non-cardiac diseases, there is a critical need to establish and develop a standardized and fully automated approach for real-time IVC collapsibility analysis and RAP estimation.

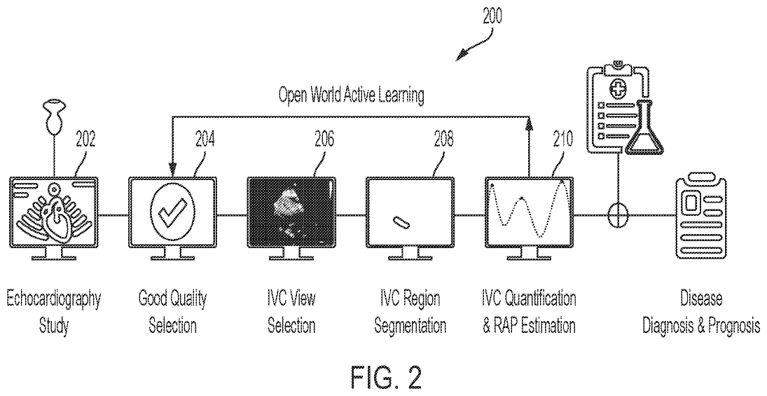

FIG. 2 illustrates an end-to-end and automated AI system 200 for estimating IVC collapsibility and RAP in real-time. As illustrated in FIG. 2, an echocardiography study 202 is performed where images are captured and high quality images 204 from the study are input into the system 200 for analysis. Using the high quality images 204, the system 200 performs real-time subcostal IVC view selection and IVC image quality assessment 206, IVC region segmentation 208, and IVC diameter quantification, collapsibility and RAP estimation 210. Below, these algorithms are described for performing the IVC view retrieval and quality assessment 206, IVC region segmentation 208, and IVC quantification and collapsibility, and RAP estimation 210.

### IVC View Selection and Quality Assessment

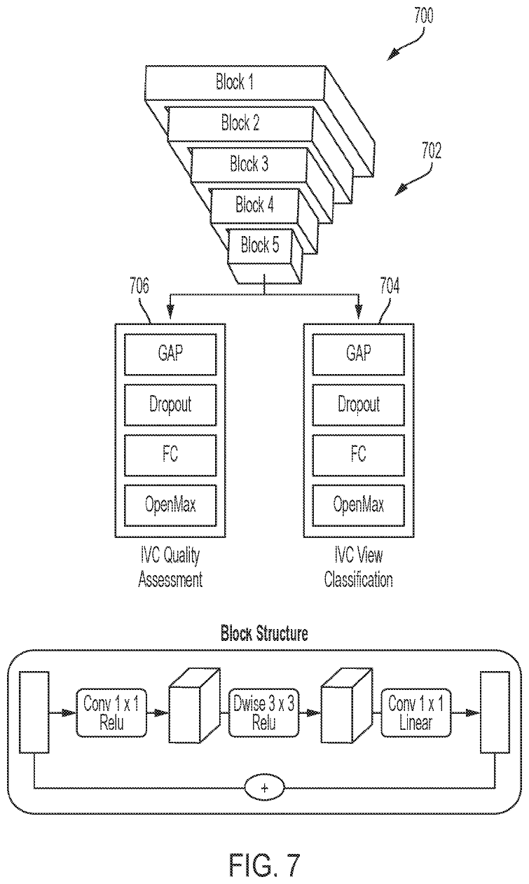

The image retrieval network 206 of the system 200 retrieves a specific view with acceptable (moderate to good) quality. The retrieval is performed with a lightweight model with a shared encoder and two heads (see FIG. 7 and related discussion below for further details), with the first head for view classification to identify an IVC view and the second head for quality assessment to assess the quality of the identified view.

The image retrieval network 206 includes five inverted residual bottleneck (see MobileNetV2-s residual bottleneck [8]) blocks and a final pooling layer. The two heads perform view classification and quality assessment, and are configured to operate with an encoder. Each head has the following layers: a Global Average Pooling (GAP) layer, a Dropout layer, Fully Connected (FC) layers, and an OpenMax layer. Each head, along with the encoder, are tuned by: (1) initializing the encoder with echo-specific weights; and (2) fine-tuning the encoder and its view classification layers. The view classification head detects an IVC view from a given echo study while the quality assessment head labels a given IVC view as good quality or bad quality. Accordingly, the model includes three task-specific layers, and both heads share the same encoder. Also, both heads may be configured to work concurrently or in parallel, which further increases network efficiency of the image retrieval component 206.

In clinical practice, echocardiographers visually identify echo views and manually exclude low-quality echoes as they lead to inaccurate measurements. The image retrieval component 206 enables automated real-time IVC view classification and quality assessment in clinical practice. The performance for view classification and quality assessment using the image retrieval component 206 is provided in Table 1 and Table 2, respectively. From the tables, it is seen that the image retrieval component 206 achieves comparable, if not better, performance as compared to the state-of-the-art echocardiography systems while having lower computational complexity. Further, the image retrieval component 206, in a particular embodiment, has 55620 parameters, which is smaller than most prior art networks in the literature; for example, VGG16 has 138 MM parameters (528 MB), and ResNet18 has 11 MM (44 MB).

TABLE 1
Performance (Mean ± Standard Deviation (SD))
of view classification head and state-of-the-art models.

| Model | Accuracy | AUC | Sensitivity | Precision | F-score |
|---|---|---|---|---|---|
| Proposed | 0.977 ± 0.01 | 0.985 ± 0.02 | 0.978 ± 0.07 | 0.977 ± 0.06 | 0.974 ± 0.06 |
| VGG | 0.953 ± 0.02 | 0.958 ± 0.04 | 0.954 ± 0.02 | 0.953 ± 0.03 | 0.954 ± 0.02 |
| ResNet | 0.936 ± 0.11 | 0.951 ± 0.03 | 0.938 ± 0.10 | 0.935 ± 0.12 | 0.936 ± 0.11 |

TABLE 2
Performance (Mean ± SD) of quality assessment head and state-of-the-art models.

| Model | Accuracy | AUC | Sensitivity | Precision | F-score |
|---|---|---|---|---|---|
| Proposed | 0.943 ± 0.10 | 0.962 ± 0.22 | 0.946 ± 0.09 | 0.944 ± 0.04 | 0.945 ± 0.06 |
| VGG | 0.933 ± 0.15 | 0.951 ± 0.43 | 0.933 ± 0.34 | 0.932 ± 0.29 | 0.933 ± 0.30 |
| ResNet | 0.913 ± 0.02 | 0.933 ± 0.05 | 0.914 ± 0.03 | 0.912 ± 0.02 | 0.912 ± 0.05 |

These results shown in Tables 1 and 2 demonstrate the superiority of the image retrieval component 206, which is based on a shared encoder with two heads for view classification and quality assessment. After retrieving high quality images using image retrieval component 206, the bad quality IVC images are automatically excluded from further analysis while the good quality echoes are sent to the IVC Region Segmentation network 208.

### IVC Region Segmentation

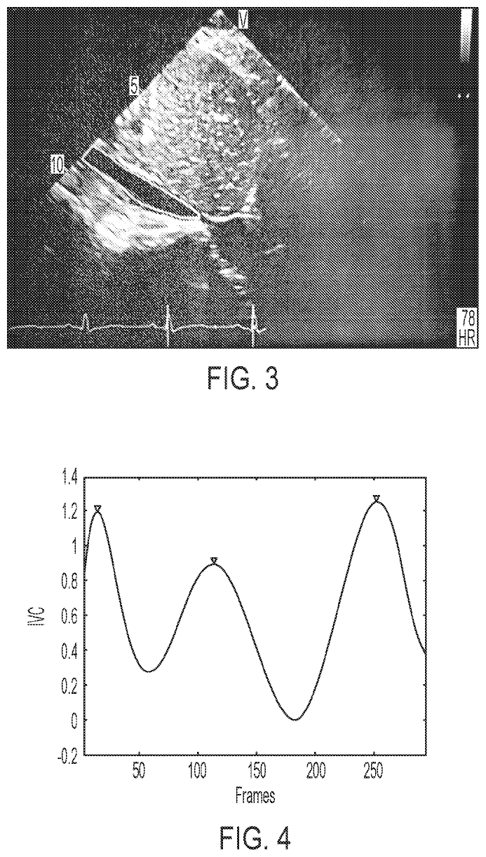

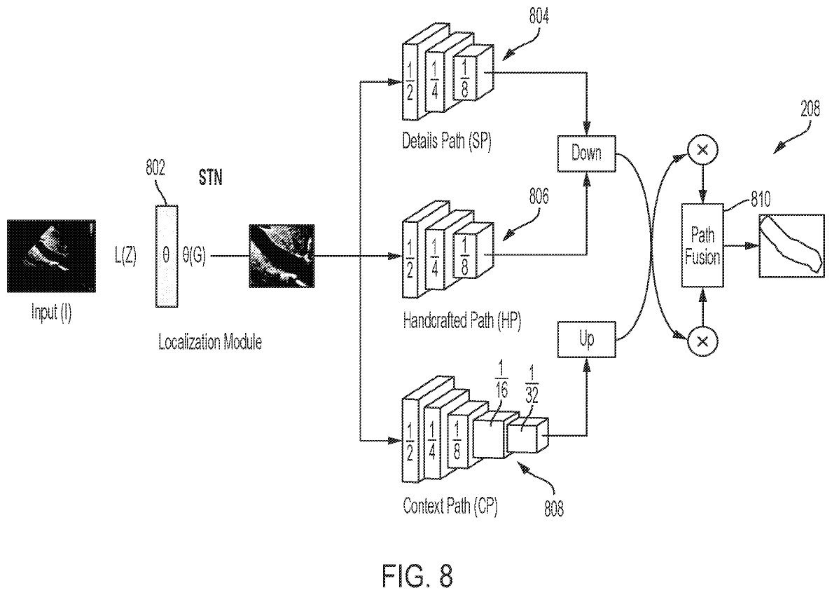

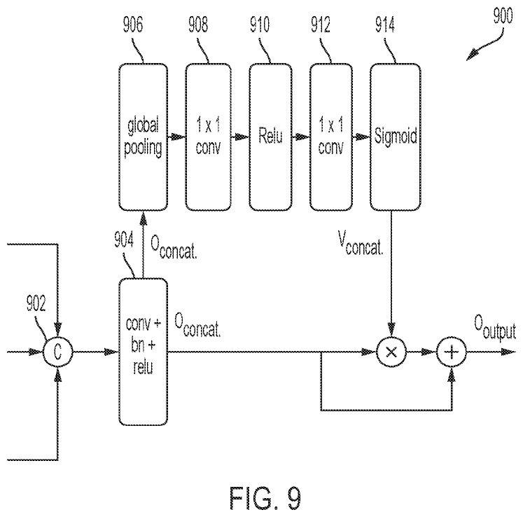

The IVC Region Segmentation network 208 detects and segments the IVC region using a novel, lightweight, and technically efficient network called a Trilateral Attention Network (TaNet) (see FIGS. 8-9 and related discussion below for further details). The TaNet of the IVC Region Segmentation network 208 achieves excellent performance segmenting IVC in each frame from the image retrieval component 206. In certain embodiments, the TaNet network achieves high accuracy of 98% and an intersection over union of 96%, and at a high speed of 85 frames per second (FPS). This speed is much faster than most widely used segmentation networks (e.g., Unet and FCN). FIG. 3 illustrates IVC segmentation using TaNet of the IVC Region Segmentation network 208 and the ground truth annotation.

### Real-Time IVC Quantification

Instead of extracting cardiac biomarkers in specific frames (e.g., end-diastolic and end-systolic) as is done manually, the IVC Quantification and RAP estimation network 210 performs temporal analysis of cardiac indices over all frames thereby improving reproducibility in clinical cardiology practice and research. Analysis of all frames provides information about temporal changes during respiration over multiple cardiac cycles. This temporal IVC analysis allows measuring IVC collapsibility, which is an important component for estimating RAP.

Prior to the delineation of IVC boundaries and calculating a diameter, the IVC Quantification and RAP estimation network 210 performs a morphological cleaning to remove any isolated unneeded pixels and only keep a closed region of interest. Next, the IVC Quantification and RAP estimation network 210 computes a contour of clean regions using a Moore-Neighbor tracing algorithm modified by Jacob's stopping criteria (see Pradhan, Ratika, et al. “Contour line tracing algorithm for digital topographic maps.” International Journal of Image Processing (IJIP) 4.2 (2010): 156-163, which is incorporated herein by reference, for a description of the algorithm). Next, the IVC Quantification and RAP estimation network 210 divides the delineated region into equal segments (or sectors). To compute a IVC diameter (IVCD), the IVC Quantification and RAP estimation network 210 finds the major axis of a sub-segment that is located approximately 2 cm proximal to the ostium of RA. The IVC Quantification and RAP estimation network 210 then computes a Euclidean distance between endpoints of the major axis. Finally, the IVC Quantification and RAP estimation network 210 converts the computed pixel distance into millimeters (mm).

After computing IVCD, the IVC Quantification and RAP estimation network 210 constructs the IVCD curve by plotting IVCD values over frames. Next, the IVC Quantification and RAP estimation network 210 uses a Savitzky-Golay filter to obtain a smoothed IVCD curve. The smoothed curve is then used to compute RAP.

RAP is computed as follows: (1) the IVC Quantification and RAP estimation network 210 computes IVC collapsibility based on a difference between an absolute maximum peak and minimum valley in the IVCD curve; and (2) the IVC Quantification and RAP estimation network 210 computes the RAP value by plugging the IVC diameter and collapsibility values into equation (1).

$$RAP ( A S E ) = \{ \begin{matrix}if IVC \leq 21 mm and collapse > 50 \% ⇒ RAP = 3 \\ if IVC \leq 21 mm and collapse < 50 \% ⇒ RAP = 8 \\ if IVC > 21 mm and collapse < 50 \% ⇒ RAP = 15 \\ \\ if IVC > 21 mm and collapse > 50 \% ⇒ RAP = 15\end{matrix} \qquad ( 1 )$$

Equation (1) is for calculating RAP using the standard equation configured for the American Association of Echocardiography (ASE). Equation (1) is an exemplary equation for calculating RAP and can be adapted for various site specific applications. For instance, the system 200 (see FIG. 2) is adjustable such that any site specific version of the above RAP equation can be utilized to determine RAP within the context of the relevant site.

FIG. 4 shows the computed IVC diameter in each frame plotted as a temporal signal. From this curve, the IVC Quantification and RAP estimation network 210 can estimate the absolute maximum value (highest peak) of this measurement and the absolute minimum value (lowest valley). The IVC Quantification and RAP estimation network 210 can also estimate the average maximum and average minimum by averaging the curve's peaks and valleys.

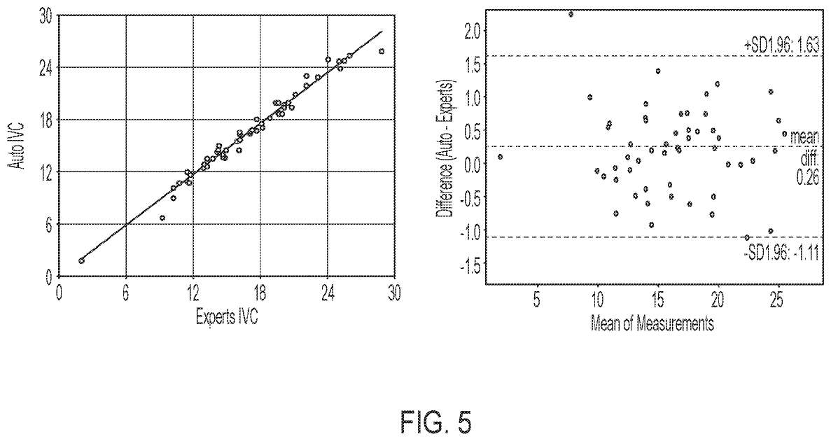

To assess the agreement between the automated values and those estimated by experts to thereby determine the efficacy of the IVC Quantification and RAP estimation network 210, a Pearson correlation coefficient and Bland-Altman analysis are performed. FIG. 5 shows correlation and Bland-Altman plots for the automated IVC of the IVC Quantification and RAP estimation network 210 as compared to the standard manual IVC quantification. From FIG. 5, it is observed that the IVC quantification extracted by the IVC Quantification and RAP estimation network 210 is highly correlated with values calculated by human experts.

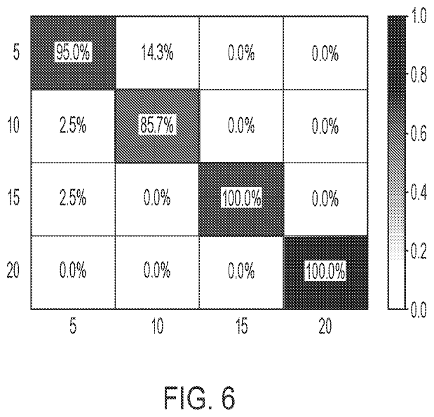

For estimating RAP, the IVC Quantification and RAP estimation network 210 measures the collapsibility of IVC. Next, the IVC Quantification and RAP estimation network 210 plugs the absolute IVC value and a percentage of collapsibility into equation (1) to estimate RAP. To assess the efficacy of the RAP estimation performed by the IVC Quantification and RAP estimation network 210, the automated RAP values are compared against those estimated by experts. FIG. 6 illustrates a confusion matrix showing this comparison. From the confusion matrix in FIG. 6, it is concluded that the IVC Quantification and RAP estimation network 210 is able to accurately estimate RAP values based on the segmented IVC region.

The automatically calculated IVC can be then combined with other clinical and laboratory biomarkers for diagnostic purposes. Such automation can greatly enhance current practice especially in low and middle resource regions, where there is a lack of expertise and limited availability of advanced laboratory and imaging diagnostic resources. An added benefit of this automation technology will be enabling standardized and personalized diagnosis and prognosis based on IVC and other laboratory and clinical biomarkers. Other benefits include accelerating and enabling the streamlining of tedious tasks (e.g., visual IVC observation) in clinical practice, potentially saving hours of physicians' time and allowing them to focus on innovation and discovery. Further, the ability of artificial intelligence (AI)-based technology to simultaneously monitor and analyze several sources of data can play a significant role in preventive medicine, potentially leading to better patient outcomes. More details about the invention's components, including IVC retrieval, segmentation, diameter quantification, and RAP estimation can be found in Ghada Zamzmi, Sivarama Krishanan Rajaraman, Li-Yueh Hsu, Vandana Sachdev, and Sameer Antani, Real time Echocardiography Image Analysis and Quantification of Cardiac Indices, Medical Image Analysis 80 (2022) 102438, which is incorporated herein by reference.

### Lightweight System for Real-Time Quantitative Echocardiography Assessment

The system 200 described above from FIG. 2 is designed to be efficient in terms of space and speed. The efficiency occurs because of the efficient design of the classification and segmentation algorithms. The following describes the structural components and related functionality of the system 200.

### Lightweight Retrieval Network

The IVC view classification and quality assessment 206 is performed by an IVC retrieval network 700 illustrated in FIG. 7. As described above, the IVC retrieval network 700 uses a single shared encoder 702 and two task-specific heads 704 and 706, each head having three task-specific layers in the illustrated embodiment. In certain embodiments, the two heads 704 and 706 can operate concurrently to further enhance IVC retrieval network 700 efficiency. Table 3 below presents a size of the IVC retrieval network 700 and the inference time, in accordance with a particular embodiment.

TABLE 3
Comparison of computational complexity.

| Model | Size | ≈Inference |
|---|---|---|
| IVC Retrieval | <20 MB | ≈0.221 seconds |
| TaNet Segmentation | <0 MB | >80 frames per second |

### Lightweight Segmentation Network

As for the IVC Region Segmentation network 208 (see FIG. 2) implemented in the form of TaNet, the experimental results discussed above showed that the proposed network achieved very rapid performance segmenting IVC (i.e., TaNet achieved 85 frames per second (FPS) IVC segmentation rate, in certain embodiments). Accordingly, the IVC Region Segmentation network 208 is a lightweight network.

The IVC Region Segmentation network 208, referred to hereinafter as TaNet 208, is used to localize the IVC region. TaNet 208 uses a localization component and three pathways for learning rich textural, low-level, and context features. TaNet 208 is fine-tuned end-to-end to learn localization and segmentation. The joint learning of localization and segmentation within TaNet 208 prevents unnecessary repetitions of training individual models in isolation and allows TaNet 208 to focus on specific IVC regions. Using a single network for both region localization and segmentation increases the efficiency of the system 200. A diagram of the efficient TaNet 208 is shown in FIG. 8.

### TaNet for IVC Region Localization and Segmentation

Convolutional Neural Networks (CNNs) often operate on the whole image and are limited by the spatial invariance of input data. The traditional approach for handling these issues involves using separate models for spatial transformation and localization. Jaderberg et al. [6] proposed a more efficient spatial transformation network, called STN, for applying these transformations (e.g., scaling, translation, attention) to the input image or feature map without additional training supervision. STN is a plug-and-play module that can be inserted into existing CNNs. It is also differentiable in the sense that it computes the derivative of the transformations within the module, which allows learning loss gradients with respect to module parameters. In IVC segmentation, the target region occupies a relatively small portion of an entire image (see FIG. 1). Hence, considering an entire image for segmentation would add noise caused by irrelevant regions. Accordingly, TaNet 208 uses STN 802 for focusing the attention of the segmentation on a specific region while suppressing irrelevant regions.

### IVC Segmentation

The segmentation is performed using three pathways: a spatial or detail pathway 804, a handcrafted pathway 806, and a context pathway 808. Each of these pathways extracts a unique set of features. The spatial pathway 804, which in certain embodiments is shallow with only three convolutional layers that have high channel capacity, extracts rich low-level details at a low computational cost. Specifically, this pathway has three blocks, each containing a 3×3 convolutional layer with stride of 2 followed by batch normalization and ReLU activation. In certain embodiments, the number of filters in the first, second, and third blocks are 64, 64, and 128, respectively. In these embodiments, this pathway outputs feature maps that are ⅛ of the input image size.

The handcrafted pathway 806, which is shallow pathway with only three local binary pattern (LBP)-encoded convolutional layers, extracts rich texture features from the echo images. The mathematical formulation of these LBP-encoded convolutional kernels is presented [1]. Each LBP block has a layer with fixed anchor weights (m) followed by a second layer with learnable convolutional filters of size 1×1. The anchor weights are generated stochastically with different ranges of sparsity. As similar to propagating gradients through layers with learnable and unlearnable parameters (e.g., ReLU, Max Pooling), the entire path can be trained by back propagating the gradients through the anchor weights as well as the learnable weights. In other words, the anchor weights are left unaffected and only up-date the weights of the learnable filters. As compared to the spatial pathway 804, the handcrafted pathway 806 is designed to extract specific features (e.g., textural, geometric) that are different from the ones extracted by the spatial pathway 804. For example, the textural features (e.g., LBP) have strong ability to differentiate small differences in texture and topography especially at the boundaries between complex regions with challenging separations. Hence, the handcrafted path 806 is used to augment the spatial path 804, and extract rich textural features in different orientations, without increasing the computational burden, while the spatial path 804 is used to extract general low-level details from the image.

Finally, the context path 808 is used for fast-downsampling of the feature map to obtain a sufficient receptive field. For the context path, a lightweight model (e.g., SqueezeNet) is used for fast down-sampling of the feature map of the input image to obtain a sufficient receptive field and encode high level context information. Subsequently, a global average pooling is attached on the tail of the lightweight model to provide the maximum receptive field with global context information. In segmentation, the network analyzes the feature map of the input image at different receptive fields. The receptive field provides an indication of the extent of the scope of input data a neuron or unit within a layer can be exposed to and is defined by the filter size of a layer within a convolution neural network. The context path allows analyzing the image at different sizes of receptive fields, and it starts from the image followed by down-sampling. Specifically, as down-sampling can shrink feature representation and enlarge the receptive field, a lightweight mode is used for down-sampling the feature representation of the image. The global average pooling provides the maximum receptive field with global context information. Finally, the output of the global average pooling is up-sampled and combined with the output of other pathways, and after extracting features from the three pathways, they are combined.

The above described process could be performed by a simple summation of the feature representations; however, embeddings can degrade the performance and complicate the network optimization via the summation approach as they are different in nature and length. Accordingly, in other embodiments, to efficiently combine these pathways a path fusion 810 is performed. FIG. 9 illustrates steps performed by the path fusion 810. The path fusion 810 fuses the features from the three paths by first concatenating the pathways' outputs at step 902 and then use batch normalization to balance the different scales of the features. Then, the concatenated features are combined into a single feature vector at step 904. This feature vector is sent to a global pooling at step 906 and followed by a convolutional layer (1×1) at step 908, at step 910 a Rectified Linear Unit (ReLU) activation is performed, at step 912 a convolutional layer (1×1) is applied, and finally, at step 914 a Sigmoid function is used to generate the weight vector. This weight vector is used to re-weight the concatenated feature vector.

### Training TaNet for Joint IVC Localization and Segmentation

TaNet 208 (see FIG. 8) is trained in two stages: pretraining and fine-tuning. In the pre-training stage, there are two steps: 1) pre-training the coarse segmentation model (CSM) and 2) pretraining the localization network (L). The coarse segmentation model (CSM) is trained to get rough predictions of an IVC region of interest (ROI). Then, the localization network (L) is trained to estimate the approximate location of IVC ROI. In a particular embodiment, to generate rough ROIs, the coarse segmentation model (CSM) is trained with a batch size of 32. This can be performed using an Adam optimizer to minimize the loss between GT masks and the predicted coarse segmentation masks. Then, the output of the coarse segmentation (z) is used as input to the localization network (L). In a particular embodiment, the localization network (L) is trained with 32 batch size to optimize the Smooth L1 loss. The smooth L1 loss, which is commonly used for box regression, is less sensitive to outliers. The localization network aims to minimize the smooth L1 loss between predicted and ground truth. In the end-to-end fine-tuning stage, with the pre-trained parameters (stage 1) loaded, we fine-tuned the entire network end-to-end using the Adam optimizer. The optimization goal is to minimize the loss between IVC prediction and IVC ground truth labels.

Table 3 above presents a size of the IVC segmentation network and the inference time. The small size and high inference speed is attributed to the three shallow pathways 804, 806, and 808, each with only three layers. It is also attributed to the fact that these pathways 804, 806, and 808 extract features concurrently, which further increases the IVC Region Segmentation network 200 (see FIG. 2) efficiency. This efficient design of the IVC Region segmentation network 208 enables its use in resource-limited and handled devices for IVC segmentation as well as for other echo applications.

### IVC Quantification

IVC Quantification and RAP Estimation network 210 performs a distance calculation to find the diameter in each frame, which adds small computational complexity to the system 200. As indicated in Table 3, the system 200 has shallow and small classification, segmentation, and quantification components, and is lightweight. Being lightweight enables the system to perform real-time IVC diameter and RAP estimation in each frame as well as real-time quantification in other echo applications.

### Open-World System for Active Echocardiography Interpretation and Learning

As traditional machine learning models require samples of a specific set of classes to be available during training, these models would fail or perform poorly when facing new data that was not accounted for during training. To overcome this challenge, system 200 is designed to run efficiently in open-world clinical settings. Existing systems for automated echocardiography analysis are designed under the assumption that the examples in the testing or deployment stage must belong to the same limited number of classes that have appeared in the training stage. This assumption, which is known as a closed-world setting, may be too strict for real-world environments that are open and often have unseen examples, which can drastically weaken the robustness of the machine learning classifiers. Here, system 200 integrates an open-world active learning approach to our IVC echocardiography system by providing a feedback network. While the open-world approach is below described for IVC, this approach can be integrated and used with other echocardiography applications.

The open-world active learning approach disclosed herein has two main engines: classification engines and clustering engines. The classification engines in our system are the view classification model, the quality assessment model, and the disease diagnosis model. Each of these classification engines has a clustering engine that clusters new or unknown cases based on their similarity or other clustering metrics followed by sending these clusters to a human expert for feedback. For example, the view classification engine contains a classifier trained to recognize different echocardiography views including IVC view, but it is also trained using OpenMax (described further below) to recognize unknown views. In each run, the view classifier will either detect a specific view or label it as unknown. The clustering engine then groups unknown views into clusters (based on their similarity) to be labeled by a human expert before passing the newly labeled clusters/classes to the classification engine for model update. In case of quality assessment, if the classification engine cannot certainly provide the quality label for a specific image/view, it labels that image as unknown, groups unknown images that are similar together, and then sends these images to a human expert for feedback. In the last stage of the system, an open-world active learning approach is integrated to the disease classification model, which uses the automated IVC diameter and collapsibility. This disease classification model will classify known cardiac diseases into their respective classes and identify new (unseen) diseases as unknown. The cases with unknown labels are then grouped into different clusters and each cluster is sent back to the human expert for feedback. Based on the provided feedback, the disease classification model will then be updated.

The importance of open-world learning can be demonstrated in several IVC applications. One possible application would be to group rare cases of IVC morphology that might not exist in training data. Examples of these rare cases include a very dilated IVC with poor collapsibility due to heart failure or a very small IVC with complete collapsibility due to dehydration. Another “unknown” cluster may be IVC images that appear to collapse but actually represent artifacts in which the image appears to go out of plane of the ultrasound beam with respiration. Grouping a set of patients with similar IVC collapsibility patterns is a useful application of open-world learning.

### Classification Engine, Open-World Active Learning Classifier

In a particular embodiment, a method for identifying unknown classes is thresholding on the Softmax output, i.e., a given input image is labeled as unknown if none of the classes reaches a predetermined threshold. The performance of this approach is sensitive to the used threshold. OpenMax predicts unknown classes using the likelihood of failure and the concept of meta-recognition. To estimate if the input is unknown or “far” from known classes, the scores from the penultimate layer of CNNs (i.e., fully connected layer) are used. Then, inputs that are far (in terms of distribution) from known classes are rejected. We note that the OWE function can be replaced with one of the three methods above (Softmax thresholding, 1-vs.-rest layer, and OpenMax) or any new functions that can distinguish new classes with difference distributions.

### Clustering Engine, Cluster-Based Active Learning

In certain embodiments, a clustering algorithm is used to group similar images of unknown classes into clusters to be labeled by human experts. Several methods can be used to cluster images of unknown classes. Examples of these methods include K-medoids, K-Means, and K-Centers. The selected clustering algorithm is used to group unknown images into cluster representatives. Specifically, the embedded features of the unknown images are used to generate k clusters of unknown classes. The optimal number of clusters K can be determined empirically (e.g., elbow method) or specified by a human expert. After grouping unknown images into different clusters, a cardiologist labeled each cluster group of unknown images instead of labeling all the unknown images, which led to a significant reduction in the required time and number of human interactions. Finally, the newly labeled images (previously unknown) are sent back to the classification stage and used to augment training and update the open-world classifier.

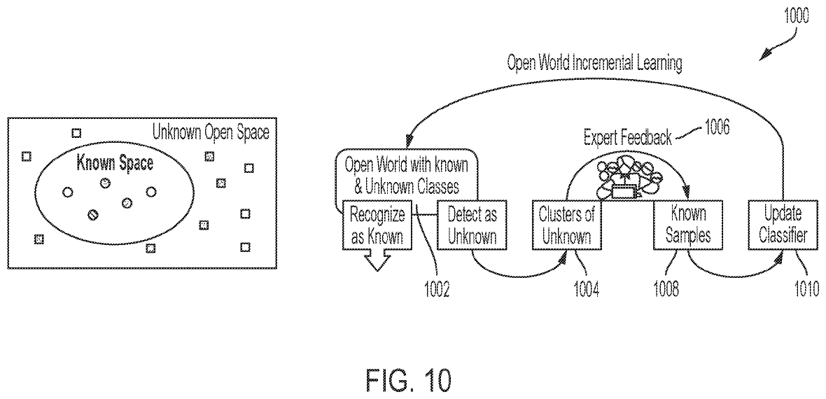

FIG. 10 illustrates an iterative process 1000 of training and updating the open-world classifier. At step 1002, the process 1000 trains an initial open-world classifier to classify known classes while identifying new (unseen) classes as unknown. At step 1004, the process 1000 uses the feature embeddings of unknown images (extracted by the encoder 702 (see FIG. 7)) and a clustering algorithm to group similar unknown samples into K clusters. At step 1006, the process 1000 presents the K clusters of unknown samples to a human expert for labeling. At step 1008, the process 1000 adds the newly labeled samples to the initially labeled data, and, at step 1010, the process 1000 re-trains the open-world classifier (returning to step 1002) using the newly labeled data. Process 1000 is repeated for labeling clusters and using them to update the open-world classifier whenever new clusters of unknown samples are created.

To evaluate the efficacy of the open-world approach, the open-world active learning approach is integrated with the view classification model. In a particular embodiment, integrating the OpenMax function along with the clustering algorithm increased the performance (F-score) of the view classification model from 0.698 to 0.858, where the 0.698 F-score is obtained using a closed-world classifier.

Automating echocardiographic IVC diameter and collapsibility assessment using a lightweight, open-world AI system, such as system 200 (see FIG. 2) is a novel and efficient approach that standardizes estimation of RAP, improves reproducibility, and positively impacts clinical management. System 200 is lightweight and can be readily implemented in any echo imaging system for real-time automatic RAP assessment. Furthermore, the open-world active learning capability of system 200 allows it to be extended to broader echocardiography interpretation and applications.

Throughout this disclosure, the following References are cited:
[1] Rao Muhammad Anwer, Fahad Shahbaz Khan, Joost Van De Weijer, Matthieu Molinier, and JormaLaaksonen. Binary patterns encoded convolutional neural networks for texture recognition and remote sensing scene classification. ISPRS journal of photogrammetry and remote sensing, 138:74-85, 2018.
[2] Abhijit Bendale and Terrance E Boult. Towards open set deep networks. In Proceedings of the IEEE conference on computer vision and pattern recognition, pages 1563-1572, 2016.
[3] Morgan Caplan, Arthur Durand, Perrine Bortolotti, Delphine Colling, Julien Goutay, Thibault Duburcq, Elodie Drumez, Anahita Rouze, Saad Nseir, Michael Howsam, et al. Measurement site of inferior vena cava diameter affects the accuracy with which fluid responsiveness can be predicted in spontaneously breathing patients: a post hoc analysis of two prospective cohorts. Annals of intensive care, 10(1): 1-10, 2020.
[4] Salvatore Di Somma, Silvia Navarin, Stefania Giordano, Francesco Spadini, Giuseppe Lippi, Gian-franco Cervellin, Bryan V Dieffenbach, and Alan S Maisel. The emerging role of biomarkers and bio-impedance in evaluating hydration status in patients with acute heart failure. Clinical Chemistry and Laboratory Medicine (CCLM), 50(12): 2093-2105, 2012.
[5] Chuanxing Geng, Sheng-jun Huang, and Songcan Chen. Recent advances in open set recognition: A survey. IEEE transactions on pattern analysis and machine intelligence, 43(10): 3614-3631, 2020.
[6] Max Jaderberg, Karen Simonyan, Andrew Zisserman, et al. Spatial transformer networks. Advances in neural information processing systems, 28, 2015.
[7] Roberto M Lang, Luigi P Badano, Victor Mor-Avi, Jonathan Afilalo, Anderson Armstrong, Laura Ernande, Frank A Flachskampf, Elyse Foster, Steven A Goldstein, Tatiana Kuznetsova, et al. Rec-ommendations for cardiac chamber quantification by echocardiography in adults: an update from the American society of echocardiography and the european association of cardiovascular imaging. European Heart Journal-Cardiovascular Imaging, 16(3): 233-271, 2015.
[8] Mark Sandler, Andrew Howard, Menglong Zhu, Andrey Zhmoginov, and Liang-Chieh Chen. Mo-bilenetv2: Inverted residuals and linear bottlenecks. In Proceedings of the IEEE conference on com-puter vision and pattern recognition, pages 4510-4520, 2018.
[9] Changqian Yu, Jingbo Wang, Chao Peng, Changxin Gao, Gang Yu, and Nong Sang. Bisenet: Bilateral segmentation network for real-time semantic segmentation. In Proceedings of the European conference on computer vision (ECCV), pages 325-341, 2018.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An Artificial Intelligence (AI) system for estimating inferior vena cava (IVC) collapsibility and right atrial pressure (RAP) from an echocardiography study in real-time, the system comprising:
an image retrieval network, the image retrieval network configured to receive images from the echocardiography study and performs a quality assessment of the images to generate selected images;
a region segmentation network, the region segmentation network configured to localize and segment the selected images to obtain IVC regions in the selected images;
an IVC quantification and RAP estimation network, the IVC quantification and RAP estimation network configured to perform a distance calculation to find a diameter in the IVC regions at different spatial (different sites) and temporal points (over time); and
an open-world active learning system, the open-world active learning system comprising a classification engine and a clustering engine.

2. The system according to claim 1, wherein the classification engine is configured to detect known views in the selected images and unknown views in the selected images.

3. The system according to claim 2, wherein the clustering engine is configured to group the unknown views into one or more clusters to use to update the classification engine.

4. The system according to claim 3, wherein the open-world active learning system is configured to:
classify the known views into known classes and the unknown views into an unknown class;
group the unknown views of the unknown class based on feature embeddings of the selected images determined by the image retrieval network;
obtain expert labeling of the unknown views of the unknown class;
add the expert labeling to the unknown views of the unknown class to determine an updated class; and
retrain the classification engine of the open-world active learning system to know the updated class.

5. The system according to claim 1, wherein the region segmentation network comprises a spatial transformation network to focus on specific regions the selected images.

6. The system according to claim 5, wherein the region segmentation network further comprises:
a spatial pathway to extract low-level details of the specific regions of the selected images;
a handcrafted pathway to extract rich texture features of the specific regions of the selected images; and
a context pathway for downsampling of a feature map to obtain a receptive field.

7. The system according to claim 6, wherein outputs of the spatial pathway, the handcrafted pathway, and the context pathway are combined using a path fusion to obtain a weighted feature vector.

8. The system according to claim 7, wherein the path fusion comprises:
concatenating the outputs of the spatial pathway, the handcrafted pathway, and the context pathway to obtain concatenated features;
combining the concatenated features into a feature vector;
sending the feature vector to a global pooling;
performing a 1×1 convolution on the feature vector after the global pooling;
performing a Rectified Linear Unit (ReLU) activation on the feature vector after the 1×1 convolution;
performing a second 1×1 convolution on the feature vector after the ReLU activation;
applying a Sigmoid function to generate a weight vector; and
re-weighting the feature vector based on the weight vector to obtain the weighted feature vector.

9. The system according to claim 1, wherein the image retrieval network comprises:
a shared encoder;
a first task-specific head; and
a second task-specific head,
wherein the first task-specific head and the second task-specific head each have at least three task-specific layers.

10. The system according to claim 1, wherein the region segmentation network is a lightweight region segmentation network configured to achieve an IVC segmentation rate of 85 frames per second (FPS).

11. A method for estimating inferior vena cava (IVC) collapsibility and right atrial pressure (RAP) from an echocardiography study in real-time performed by an Artificial Intelligence (AI) system, the method comprising:
receiving images from the echocardiography study and performing a quality assessment of the images to generate selected images;
localizing and segmenting the selected images to obtain IVC regions in the selected images;
performing a distance calculation to find a diameter in the IVC regions at different spatial and temporal points;
classifying known views and unknown views in the selected images; and
grouping the unknown views into one or more clusters used to update classification capability in the AI system.

12. The method according to claim 11, further comprising:
classifying the known views into known classes and the unknown views into an unknown class;
grouping the unknown views of the unknown class based on feature embeddings of the selected images;
obtaining expert labeling of the unknown views of the unknown class;
adding the expert labeling to the unknown views of the unknown class to determine an updated class; and
retraining the AI system to know the updated class.

13. The method according to claim 11, wherein the localizing and segmenting the selected images to obtain IVC regions in the selected images comprises:
extracting low-level details of specific regions of the selected images;
extracting rich texture features of the specific regions of the selected images; and
downsampling a feature map to obtain a receptive field.

14. The method according to claim 13, further comprising combining the low-level details of the specific regions of the selected images, the rich texture features of the specific regions of the selected images, and the receptive field using a path fusion to obtain a weighted feature vector.

15. The method according to claim 14, wherein the combining the low-level details of the specific regions of the selected images, the rich texture features of the specific regions of the selected images, and the receptive field using the path fusion comprises:
concatenating the low-level details of the specific regions of the selected images, the rich texture features of the specific regions of the selected images, and the receptive field to obtain concatenated features;
combining the concatenated features into a feature vector;
sending the feature vector to a global pooling;
performing a 1×1 convolution on the feature vector after the global pooling;
performing a Rectified Linear Unit (ReLU) activation on the feature vector after the 1×1 convolution;
performing a second 1×1 convolution on the feature vector after the ReLU activation;
applying a Sigmoid function to generate a weight vector; and
re-weighting the feature vector based on the weight vector to obtain the weighted feature vector.

16. A non-transitory computer readable medium implemented in an Artificial Intelligence (AI) system for estimating inferior vena cava (IVC) collapsibility and right atrial pressure (RAP) from an echocardiography study in real-time, the non-transitory computer readable medium comprising instructions that when executed by a computer, configure the computer to perform steps comprising:
receiving images from the echocardiography study and performing a quality assessment of the images to generate selected images;
localizing and segmenting the selected images to obtain IVC regions in the selected images;
performing a distance calculation to find a diameter in the IVC regions at different spatial and temporal points;
classifying known views and unknown views in the selected images; and
grouping the unknown views into one or more clusters used to update classification capability in the AI system.

17. The non-transitory computer readable medium according to claim 16, further comprising instructions that when executed configure the computer to perform further steps comprising:
classifying the known views into known classes and the unknown views into an unknown class;
grouping the unknown views of the unknown class based on feature embeddings of the selected images;
obtaining expert labeling of the unknown views of the unknown class;
adding the expert labeling to the unknown views of the unknown class to determine an updated class; and
retraining the AI system to know the updated class.

18. The method according to claim 16, wherein the localizing and segmenting the selected images to obtain IVC regions in the selected images comprises:
extracting low-level details of specific regions of the selected images;
extracting rich texture features of the specific regions of the selected images; and
downsampling a feature map to obtain a receptive field.

19. The method according to claim 18, further comprising instructions that when executed configure the computer to perform further steps comprising combining the low-level details of the specific regions of the selected images, the rich texture features of the specific regions of the selected images, and the receptive field using a path fusion to obtain a weighted feature vector.

20. The method according to claim 19, wherein the combining the low-level details of the specific regions of the selected images, the rich texture features of the specific regions of the selected images, and the receptive field using the path fusion comprises:
concatenating the low-level details of the specific regions of the selected images, the rich texture features of the specific regions of the selected images, and the receptive field to obtain concatenated features;
combining the concatenated features into a feature vector;
sending the feature vector to a global pooling;
performing a 1×1 convolution on the feature vector after the global pooling;
performing a Rectified Linear Unit (ReLU) activation on the feature vector after the 1×1 convolution;
performing a second 1×1 convolution on the feature vector after the ReLU activation;
applying a Sigmoid function to generate a weight vector; and
re-weighting the feature vector based on the weight vector to obtain the weighted feature vector.
